(19) United States
(12) Patent Application Publication
(10) Pub. No.: US 2016/0065959 A1
(43) Pub. Date: Mar. 3, 2016

(54) LEARNING-BASED PARTITIONING FOR VIDEO ENCODING

(71) Applicant: Lyrical Labs Video Compression Technology, LLC, New York, NY (US)

(72) Inventors: John David Stobaugh, El Dorado, AR (US); Edward Ratner, Iowa City, IA (US)

(21) Appl. No.: 14/737,401

(22) Filed: Jun. 11, 2015

Related U.S. Application Data
(60) Provisional application No. 62/042,188, filed on Aug. 26, 2014.

(51) Int. Cl. H04N 19/115; H04N 19/46

(52) U.S. Cl. CPC H04N 19/115; H04N 19/46

(57) ABSTRACT

In embodiments, a system for encoding video is configured to receive video data comprising a frame and identify a partitioning option. The system identifies at least one characteristic corresponding to the partitioning option, provides the at least one characteristic, as input, to a classifier, and determines, based on the classifier, whether to partition the frame according to the identified partitioning option.

### CROSS-REFERENCE TO RELATED APPLICATION

This application claims priority to Provisional Application No. 62/042,188, filed on Aug. 26, 2014, the entirety of which is hereby incorporated by reference for all purposes.

### BACKGROUND

The technique of breaking a video frame into smaller blocks for encoding has been common to the h.26x family of video coding standards since the release of h.261. The latest version, h.265, uses blocks of sizes up to 64 samples, and utilizes more reference frames and greater motion vector ranges than its predecessors. In addition, these blocks can be partitioned into smaller sub-blocks. The frame sub blocks in h.265 are referred to as Coding Tree Units (CTUs). In H.264 and VP8, these are known as macroblocks and are 16×16. These CTUs can be subdivided into smaller blocks called Coding Units (CUs). While CUs provide greater flexibility in referencing different frame locations, they may also be computationally expensive to locate due to multiple cost calculations performed with respect to CU candidates. Often many CU candidates are not used in a final encoding.

A common strategy for selecting a final CTU follows a quad tree, recursive structure. A CU's motion vectors and cost are calculated. The CU may be split into multiple (e.g., four) parts and a similar cost examination may be performed for each. This subdividing and examining may continue until the size of each CU is 4×4 samples. Once the cost of each sub-block for all the viable motion vectors is calculated, they are combined to form a new CU candidate. This new candidate is then compared to the original CU candidate and the CU candidate with the higher rate-distortion cost is discarded. This process may be repeated until a final CTU is produced for encoding. With the above approach, unnecessary calculations may be made at each CTU for both divided and undivided CU candidates. Additionally, conventional encoders may examine only local information.

### SUMMARY

In an Example 1, a method for encoding video comprises receiving video data comprising a frame; identifying a partitioning option; identifying at least one characteristic corresponding to the partitioning option; providing the at least one characteristic, as input, to a classifier; and determining, based on the classifier, whether to partition the frame according to the identified partitioning option.

In an Example 2, the method of Example 1 wherein the partitioning option comprises a coding tree unit (CTU).

In an Example 3, the method of Example 2 wherein identifying the partitioning option comprises: identifying a first candidate coding unit (CU) and a second candidate CU; determining a first cost associated with the first candidate CU and a second cost associated with the second candidate CU; and determining that the first cost is lower than the second cost.

In an Example 4, the method of Example 3, wherein the at least one characteristic comprises at least one characteristic of the first candidate CU.

In an Example 5, the method of any of Examples 1-4, wherein identifying at least one characteristic corresponding to the partitioning option comprises determining at least one of the following: an overlap between the first candidate CU and at least one of a segment, an object, and a group of objects; a ratio of a coding cost of the first candidate CU to an average coding cost of the video frame; a neighbor CTU split decision history; and a level in a CTU quad tree structure corresponding to the first candidate CU.

In an Example 6, the method of any of Examples 1-5, wherein providing the at least one characteristic, as input, to the classifier comprises providing a characteristic vector to the classifier, wherein the characteristic vector includes the at least one characteristic.

In an Example 7, the method of any of Examples 1-6, wherein the classifier comprises a neural network or a support vector machine.

In an Example 8, the method of any of Examples 1-7, further comprising: receiving a plurality of test videos; analyzing each of the plurality of test videos to generate training data; and training the classifier using the generated training data.

In an Example 9, the method of Example 8, wherein the training data comprises at least one of localized frame information, global frame information, output from object group analysis and output from segmentation.

In an Example 10, the method of any of Examples 8-9, wherein the training data comprises a ratio of an average cost for a test frame to a cost of a local CU in the test frame.

In an Example 11, the method of any of Examples 8-10, wherein the training data comprises a cost decision history of a local CTU in the test frame.

In an Example 12, the method of Example 11, wherein the cost decision history of the local CTU comprises a count of a number of times a split CU is used in a corresponding final CTU.

In an Example 13, the method of any of Examples 8-12, wherein the training data comprises an early coding unit decision.

In an Example 14, the method of any of Examples 8-13, wherein the training data comprises a level in a CTU tree structure corresponding to a CU.

In an Example 15, the method of any of Examples 1-16, further comprising: performing segmentation on the frame to produce segmentation results; performing object group analysis on the frame to produce object group analysis results; and determining, based on the classifier, the segmentation results, and the object group analysis results, whether to partition the frame according to the identified partitioning option.

In an Example 16, one or more computer-readable media includes computer-executable instructions embodied thereon for encoding video, the instructions comprising: a partitioner configured to identify a partitioning option comprising a candidate coding unit; and partition the frame according to the partitioning option; a classifier configured to facilitate a decision as to whether to partition the frame according to the identified partitioning option, wherein the classifier is configured to receive, as input, at least one characteristic corresponding to the candidate coding unit; and an encoder configured to encode the partitioned frame.

In an Example 17, the media of Example 16, wherein the classifier comprises at least one of a neural network and a support vector machine.

In an Example 18, the media of any of Examples 16 and 17, the instructions further comprising a segmenter configured to segment the video frame into a plurality of segments; and provide information associated with the plurality of segments, as input, to the classifier.

In an Example 19, a system for encoding video comprises a partitioner configured to receive a video frame; identify a first partitioning option corresponding to the video frame and a second partitioning option corresponding to the video frame; determine that a cost associated with the first partitioning option is lower than a cost associated with the second partitioning option; and partition the video frame according to the first partitioning option. The system also includes a classifier, stored in a memory, wherein the partitioner is further configured to provide, as input, at least one characteristic of the first partitioning option to the classifier and to use an output from the classifier to facilitate determining that the cost associated with the first partitioning option is lower than the cost associated with the second partitioning option; and an encoder configured to encode the partitioned video frame.

In an Example 20, the system of Example 19, wherein the classifier comprises a neural network or a support vector machine.

### BRIEF DESCRIPTION OF THE DRAWINGS

FIG. 1 is a block diagram illustrating an operating environment (and, in some embodiments, aspects of the present invention) in accordance with embodiments of the present invention;

FIG. 2 is a flow diagram depicting an illustrative method of encoding video in accordance with embodiments of the present invention;

FIG. 3 is a flow diagram depicting an illustrative method of partitioning a video frame in accordance with embodiments of the present invention;

FIG. 4 is a flow diagram depicting an illustrative method of encoding video in accordance with embodiments of the present invention; and

FIG. 5 is a flow diagram depicting another illustrative method of partitioning a video frame in accordance with embodiments of the present invention.

While the present invention is amenable to various modifications and alternative forms, specific embodiments have been shown by way of example in the drawings and are described in detail below. The present invention, however, is not limited to the particular embodiments described. On the contrary, the present invention is intended to cover all modifications, equivalents, and alternatives falling within the ambit of the present invention as defined by the appended claims.

Although the term “block” may be used herein to connote different elements illustratively employed, the term should not be interpreted as implying any requirement of, or particular order among or between, various steps disclosed herein unless and except when explicitly referring to the order of individual steps.

### DETAILED DESCRIPTION

Embodiments of the invention use a classifier to facilitate efficient coding unit (CU) examinations. The classifier may include, for example, a neural network classifier, a support vector machine, a random forest, a linear combination of weak classifiers, and/or the like. The classifier may be trained using various inputs such as, for example, object group analysis, segmentation, localized frame information, and global frame information. Segmentation on a still frame may be generated using any number of techniques. For example, in embodiments, an edge detection based method may be used. Additionally, a video sequence may be analyzed to ascertain areas of consistent inter frame movements which may be labeled as objects for later referencing. In embodiments, the relationships between the CU being examined and the objects and segments may be inputs for the classifier.

According to embodiments, frame information may be examined both on a global and local scale. For example, the average cost of encoding an entire frame may be compared to a local CU encoding cost and, in embodiments, this ratio may be provided, as an input, to the classifier. As used herein, the term “cost” may refer to a cost associated with error from motion compensation for a particular partitioning decision and/or costs associated with encoding motion vectors for a particular partitioning decision. These and various other, similar, types of costs are known in the art and may be included within the term “costs” herein. Examples of these costs are defined in U.S. application Ser. No. 13/868,749, filed Apr. 23, 2013, entitled “MACROBLOCK PARTITIONING AND MOTION ESTIMATION USING OBJECT ANALYSIS FOR VIDEO COMPRESSION,” the disclosure of which is expressly incorporated by reference herein.

Another input to the classifier may include a cost decision history of local CTUs that have already been processed. This may be, e.g., a count of the number of times a split CU was used in a final CTU within a particular region of the frame. In embodiments, the Early Coding Unit decision, as developed in the Joint Video Team's Video Coding HEVC Test Model 12, may be provided, as input, to the classifier. Additionally, the level of the particular CU in the quad tree structure may be provided, as input, to the classifier.

According to embodiments, information from a number of test videos may be used to train a classifier to be used in future encodings. In embodiments, the classifier may also be trained during actual encodings. That is, for example, the classifier may be adapted to characteristics of a new video sequence for which it may subsequently influence the encoder's decisions of whether to bypass unnecessary calculations.

According to various embodiments of the invention, a pragmatic partitioning analysis may be employed, using a classifier to help guide the CU selection process. Using a combination of segmentation, object group analysis, and a classifier, the cost decision may be influenced in such a way that human visual quality may be increased while lowering bit expenditures. For example, this may be done by allocating more bits to areas of high activity than are allocated to areas of low activity. Additionally, embodiments of the invention may leverage correlation information between CTUs to make more informed global decisions. In this manner, embodiments of the invention may facilitate placing greater emphasis on areas that are more sensitive to human visual quality, thereby potentially producing a result of higher quality to end-users.

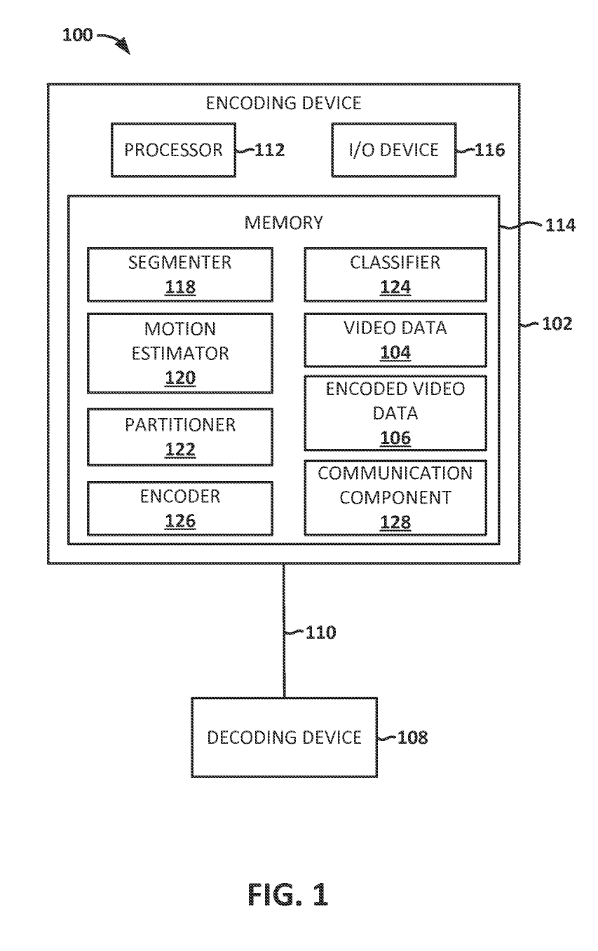

FIG. 1 is a block diagram illustrating an operating environment 100 (and, in some embodiments, aspects of the present invention) in accordance with embodiments of the present invention. The operating environment 100 includes an encoding device 102 that may be configured to encode video data 104 to create encoded video data 106. As shown in FIG. 1, the encoding device 102 may also be configured to communicate the encoded video data 106 to a decoding device 108 via a communication link 110. In embodiments, the communication link 110 may include a network. The network may be, or include, any number of different types of communication networks such as, for example, a short messaging service (SMS), a local area network (LAN), a wireless LAN (WLAN), a wide area network (WAN), the Internet, a P2P network, and/or the like. The network may include a combination of multiple networks.

As shown in FIG. 1, the encoding device 102 may be implemented on a computing device that includes a processor 112, a memory 114, and an input/output (I/O) device 116. Although the encoding device 102 is referred to herein in the singular, the encoding device 102 may be implemented in multiple instances, distributed across multiple computing devices, instantiated within multiple virtual machines, and/or the like. In embodiments, the processor 112 executes various program components stored in the memory 114, which may facilitate encoding the video data 106. In embodiments, the processor 112 may be, or include, one processor or multiple processors. In embodiments, the I/O device 116 may be, or include, any number of different types of devices such as, for example, a monitor, a keyboard, a printer, a disk drive, a universal serial bus (USB) port, a speaker, pointer device, a trackball, a button, a switch, a touch screen, and/or the like.

According to embodiments, as indicated above, various components of the operating environment 100, illustrated in FIG. 1, may be implemented on one or more computing devices. A computing device may include any type of computing device suitable for implementing embodiments of the invention. Examples of computing devices include specialized computing devices or general-purpose computing devices such “workstations,” “servers,” “laptops,” “desktops,” “tablet computers,” “hand-held devices,” and the like, all of which are contemplated within the scope of FIG. 1 with reference to various components of the operating environment 100. For example, according to embodiments, the encoding device 102 (and/or the video decoding device 108) may be, or include, a general purpose computing device (e.g., a desktop computer, a laptop, a mobile device, and/or the like), a specially-designed computing device (e.g., a dedicated video encoding device), and/or the like.

Additionally, although not illustrated herein, the decoding device 108 may include any combination of components described herein with reference to encoding device 102, components not shown or described, and/or combinations of these. In embodiments, the encoding device 102 may include, or be similar to, the encoding computing systems described in U.S. application Ser. No. 13/428,707, filed Mar. 23, 2012, entitled “VIDEO ENCODING SYSTEM AND METHOD;” and/or U.S. application Ser. No. 13/868,749, filed Apr. 23, 2013, entitled “MACROBLOCK PARTITIONING AND MOTION ESTIMATION USING OBJECT ANALYSIS FOR VIDEO COMPRESSION;” the disclosure of each of which is expressly incorporated by reference herein.

In embodiments, a computing device includes a bus that, directly and/or indirectly, couples the following devices: a processor, a memory, an input/output (I/O) port, an I/O component, and a power supply. Any number of additional components, different components, and/or combinations of components may also be included in the computing device. The bus represents what may be one or more busses (such as, for example, an address bus, data bus, or combination thereof). Similarly, in embodiments, the computing device may include a number of processors, a number of memory components, a number of I/O ports, a number of I/O components, and/or a number of power supplies. Additionally any number of these components, or combinations thereof, may be distributed and/or duplicated across a number of computing devices.

In embodiments, the memory 114 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; or any other medium that can be used to store information and can be accessed by a computing device such as, for example, quantum state memory, and the like. In embodiments, the memory 114 stores computer-executable instructions for causing the processor 112 to implement aspects of embodiments of system components discussed herein and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include a segmenter 118, a motion estimator 120, a partitioner 122, a classifier 124, an encoder 126, and a communication component 128. Some or all of the functionality contemplated herein may also, or alternatively, be implemented in hardware and/or firmware.

In embodiments, the segmenter 118 may be configured to segment a video frame into a number of segments. The segments may include, for example, objects, groups, slices, tiles, and/or the like. The segmenter 118 may employ any number of various automatic image segmentation methods known in the field. In embodiments, the segmenter 118 may use image color and corresponding gradients to subdivide an image into segments that have similar color and texture. Two examples of image segmentation techniques include the watershed algorithm and optimum cut partitioning of a pixel connectivity graph. For example, the segmenter 118 may use Canny edge detection to detect edges on a video frame for optimum cut partitioning, and create segments using the optimum cut partitioning of the resulting pixel connectivity graph.

In embodiments, the motion estimator 120 is configured to perform motion estimation on a video frame. For example, in embodiments, the motion estimator may perform segment-based motion estimation, where the inter-frame motion of the segments determined by the segmenter 118 is determined. The motion estimator 120 may utilize any number of various motion estimation techniques known in the field. Two examples are optical pixel flow and feature tracking. For example, in embodiments, the motion estimator 120 may use feature tracking in which Speeded Up Robust Features (SURF) are extracted from both a source image (e.g., a first frame) and a target image (e.g., a second, subsequent, frame). The individual features of the two images may then be compared using a Euclidean metric to establish a correspondence, thereby generating a motion vector for each feature. In such cases, a motion vector for a segment may be, for example, the median of all of the motion vectors for each of the segment's features.

In embodiments, the encoding device 102 may perform an object group analysis on a video frame. For example, each segment may be categorized based on its motion properties (e.g., as either moving or stationary) and adjacent segments may be combined into objects. In embodiments, if the segments are moving, they may be combined based on similarity of motion. If the segments are stationary, they may be combined based on similarity of color and/or the percentage of shared boundaries.

In embodiments, the partitioner 122 may be configured to partition the video frame into a number of partitions. For example, the partitioner 122 may be configured to partition a video frame into a number of coding tree units (CTUs). The CTUs can be further partitioned into coding units (CUs). Each CU may include a luma coding block (CB), two chroma CBs, and an associated syntax. In embodiments, each CU may be further partitioned into prediction units (Pus) and transform units (TUs). In embodiments, the partitioner 122 may identify a number of partitioning options corresponding to a video frame. For example, the partitioner 122 may identify a first partitioning option and a second partitioning option.

To facilitate selecting a partitioning option, the partitioner 122 may determine a cost of each option and may, for example, determine that a cost associated with the first partitioning option is lower than a cost associated with the second partitioning option. In embodiments, a partitioning option may include a candidate CU, a CTU, and/or the like. In embodiments, costs associated with partitioning options may include costs associated with error from motion compensation, costs associated with encoding motion vectors, and/or the like.

To minimize the number of cost calculations made by the partitioner 122, the classifier 124 may be used to facilitate classification of partitioning options. In this manner, the classifier 124 may be configured to facilitate a decision as to whether to partition the frame according to an identified partitioning option. According to various embodiments, the classifier may be, or include, a neural network, a support vector machine, and/or the like. The classifier may be trained using test videos before and/or during its actual use in encoding.

In embodiments, the classifier 124 may be configured to receive, as input, at least one characteristic corresponding to the candidate coding unit. For example, the partitioner 122 may be further configured to provide, as input to the classifier 124, a characteristic vector corresponding to the partitioning option. The characteristic vector may include a number of feature parameters that can be used by the classifier to provide an output to facilitate determining that the cost associated with a first partitioning option is lower than the cost associated with a second partitioning option. For example, the characteristic vector may include one or more of localized frame information, global frame information, output from object group analysis and output from segmentation. The characteristic vector may include a ratio of an average cost for the video frame to a cost of a local CU in the video frame, an early coding unit decision, a level in a CTU tree structure corresponding to a CU, and a cost decision history of a local CTU in the video frame. For example, the cost decision history of the local CTU may include a count of a number of times a split CU is used in a corresponding final CTU.

As shown in FIG. 1, the encoding device 102 also includes an encoder 126 configured for entropy encoding of partitioned video frames and a communication component 128. In embodiments, the communication component 128 is configured to communicate encoded video data 106. For example, in embodiments, the communication component 128 may facilitate communicating encoded video data 106 to the decoding device 108.

The illustrative operating environment 100 shown in FIG. 1 is not intended to suggest any limitation as to the scope of use or functionality of embodiments of the present invention. Neither should the illustrative operating environment 100 be interpreted as having any dependency or requirement related to any single component or combination of components illustrated therein. Additionally, any one or more of the components depicted in FIG. 1 may be, in embodiments, integrated with various ones of the other components depicted therein (and/or components not illustrated), all of which are considered to be within the ambit of the present invention.

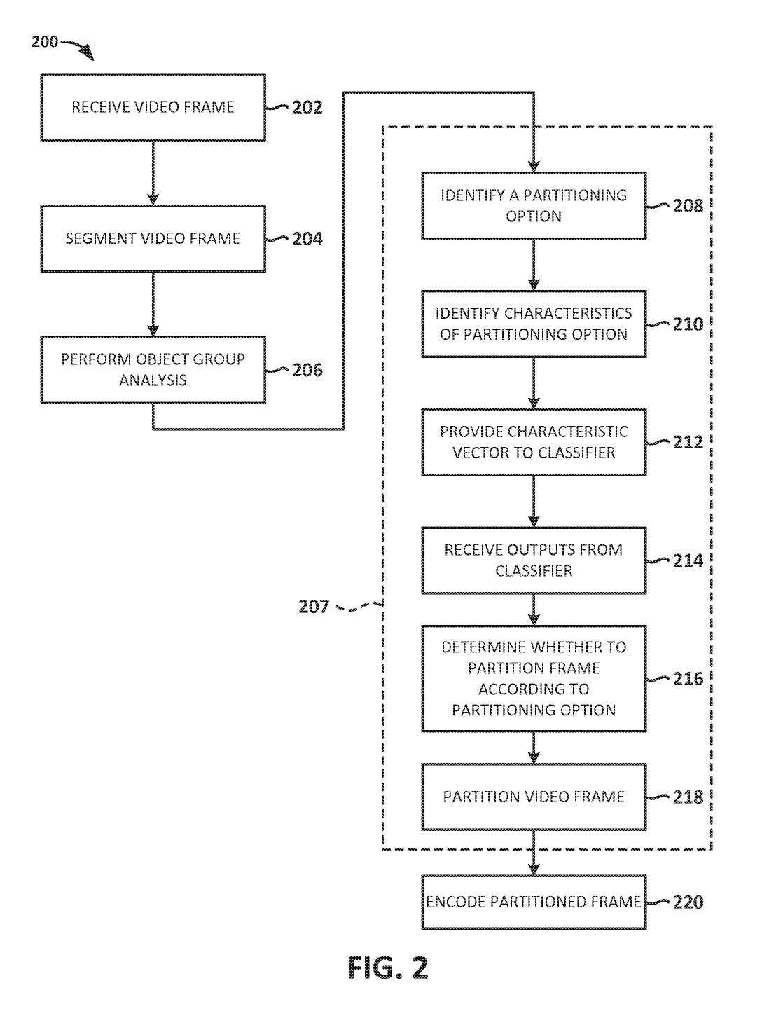

FIG. 2 is a flow diagram depicting an illustrative method 200 of encoding video. In embodiments, aspects of the method 200 may be performed by an encoding device (e.g., the encoding device 102 depicted in FIG. 1). As shown in FIG. 2, embodiments of the illustrative method 200 include receiving a video frame (block 202). In embodiments, one or more video frames may be received by the encoding device from another device (e.g., a memory device, a server, and/or the like). The encoding device may perform segmentation on the video frame (block 204) to produce segmentation results, and perform an object group analysis on the video frame (block 206) to produce object group analysis results.

Embodiments of the method 200 further include a process 207 that is performed for each of a number of coding units or other partition structures. For example, a first iteration of the process 207 may be performed for a first CU that may be a 64×64 block of pixels, then for each of four 32×32 blocks of the CU, using information generated in each step to inform the next step. The iterations may continue, for example, by performing the process for each 16×16 block that makes up each 32×32 block. This iterative process 207 may continue until a threshold or other criteria are satisfied, at which point the method 200 does is not applied at any further branches of the structural hierarchy.

As shown in FIG. 2, for example, for a first coding unit (CU), identifying a partitioning option (block 208). The partitioning option may include, for example, a coding tree unit (CTU), a coding unit, and/or the like. In embodiments, identifying the partitioning option may include identifying a first candidate coding unit (CU) and a second candidate CU, determining a first cost associated with the first candidate CU and a second cost associated with the second candidate CU, and determining that the first cost is lower than the second cost.

As shown in FIG. 2, embodiments of the illustrative method 200 further include identifying characteristics corresponding to the partitioning option (block 210). Identifying characteristics corresponding to the partitioning option may include determining a characteristic vector having one or more of the following characteristics: an overlap between the first candidate CU and at least one of a segment, an object, and a group of objects; a ratio of a coding cost of the first candidate CU to an average coding cost of the video frame; a neighbor CTU split decision history; and a level in a CTU quad tree structure corresponding to the first candidate CU. In embodiments, the characteristic vector may also include segmentation results and object group analysis results.

As shown in FIG. 2, the encoding device provides the characteristic vector to a classifier (block 212) and receives outputs from the classifier (block 214). The outputs from the classifier may be used (e.g., by a partitioner such as the partitioner 124 depicted in FIG. 1) to facilitate a determination whether to partition the frame according to the partitioning option (block 216). According to various embodiments, the classifier may be, or include, a neural network, a support vector machine, and/or the like. The classifier may be trained using test videos. For example, in embodiments, a number of test videos having a variety of characteristics may be analyzed to generate training data, which may be used to train the classifier. The training data may include one or more of localized frame information, global frame information, output from object group analysis and output from segmentation. The training data may include a ratio of an average cost for a test frame to a cost of a local CU in the test frame, an early coding unit decision, a level in a CTU tree structure corresponding to a CU, and a cost decision history of a local CTU in the test frame. For example, the cost decision history of the local CTU may include a count of a number of times a split CU is used in a corresponding final CTU. As shown in FIG. 2, using the determined CTUs, the video frame is partitioned (block 218) and the partitioned video frame is encoded (block 220).

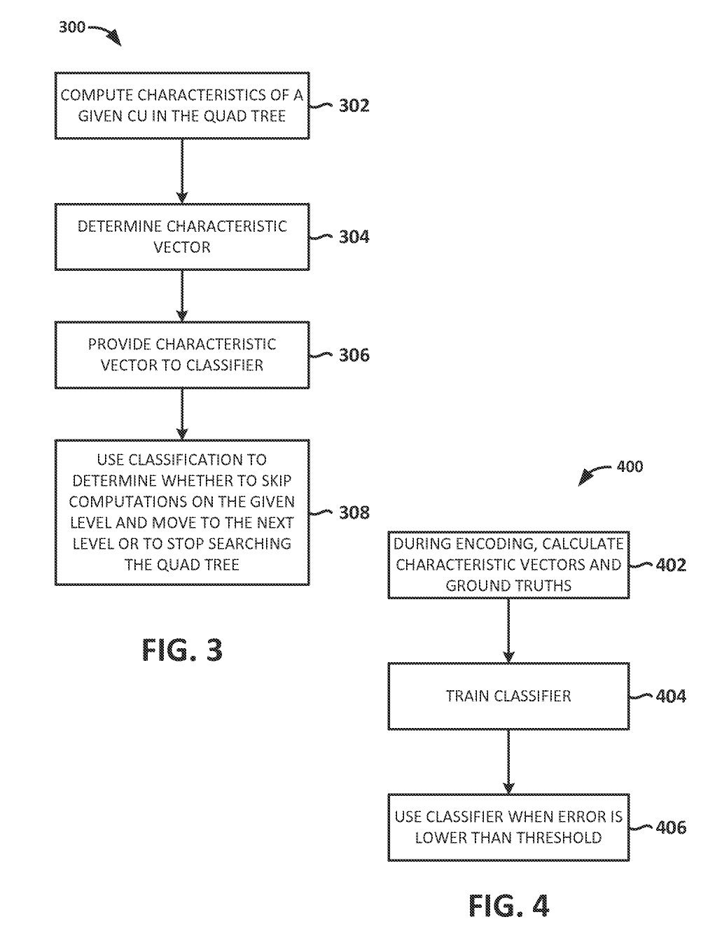

FIG. 3 is a flow diagram depicting an illustrative method 300 of partitioning a video frame. In embodiments, aspects of the method 300 may be performed by an encoding device (e.g., the encoding device 102 depicted in FIG. 1). As shown in FIG. 3, embodiments of the illustrative method 300 include computing entities needed for generating a characteristic vector of a given CU in a quad tree (block 302), as compared to other coding unit candidates. The encoding device determines a characteristic vector (block 304) and provides the characteristic vector to a classifier (block 306). As shown in FIG. 3, the method 300 further uses the resulting classification to determine whether to skip computations on the given level of the quad tree and to move to the next level, or to stop searching the quad tree (block 308).

FIG. 4 is a schematic diagram depicting an illustrative method 400 for encoding video. In embodiments, aspects of the method 400 may be performed by an encoding device (e.g., the encoding device 102 depicted in FIG. 1). As shown in FIG. 4, embodiments of the illustrative method 400 include calculating characteristic vectors and ground truths while encoding video data (block 402). The method 400 further includes training a classifier using the characteristic vectors and ground truths (block 404) and using the classifier when the error falls below a threshold (block 406).

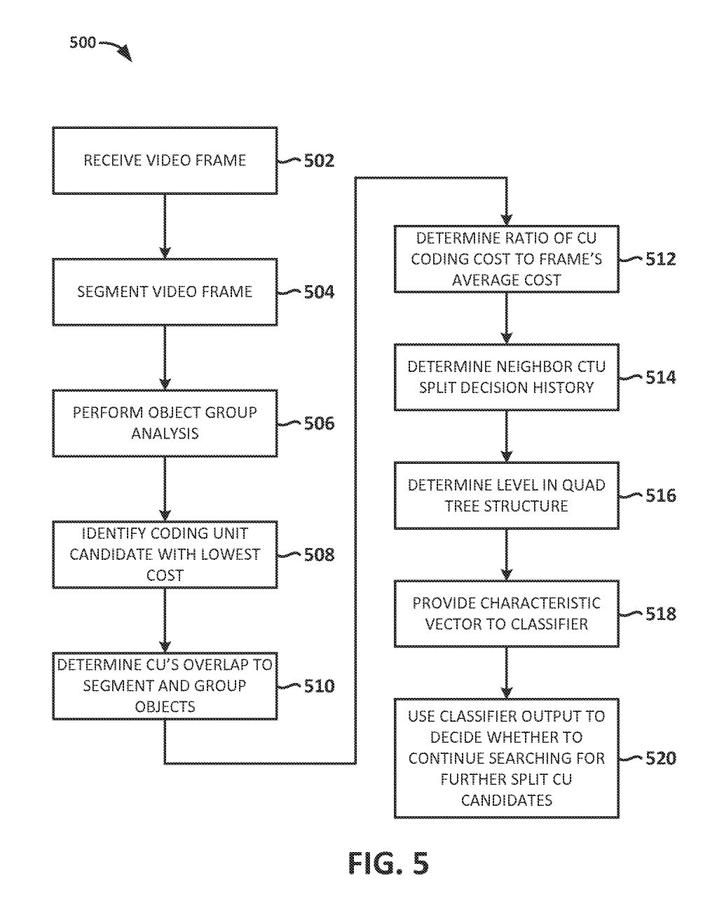

FIG. 5 is a flow diagram depicting an illustrative method 500 of partitioning a video frame. In embodiments, aspects of the method 500 may be performed by an encoding device (e.g., the encoding device 102 depicted in FIG. 1). As shown in FIG. 5, embodiments of the illustrative method 500 include receiving a video frame (block 502). The encoding device segments the video frame (block 504) and performs an object group analysis on the video frame (block 506). As shown, a coding unit candidate with the lowest cost is identified (block 508). The encoding device may then determine an amount of overlap between the coding unit candidate and one or more of the segments and/or object groups. (block 510).

As shown in FIG. 5, embodiments of the method 500 also include determining a ratio of a coding cost associated with the candidate CU to an average frame cost (block 512). The encoding device may also determine a neighbor CTU split decision history (block 514) and a level in a quad tree level corresponding to the CU candidate (block 516). As shown, the resulting characteristic vector is provided to a classifier (block 518) and the output from the classifier is used to decide whether to continue searching for further split CU candidates (block 520).

While embodiments of the present invention are described with specificity, the description itself is not intended to limit the scope of this patent. Thus, the inventors have contemplated that the claimed invention might also be embodied in other ways, to include different steps or features, or combinations of steps or features similar to the ones described in this document, in conjunction with other technologies.

1. A method for encoding video, the method comprising:
receiving video data comprising a frame;
identifying a partitioning option;
identifying at least one characteristic corresponding to the partitioning option;
providing the at least one characteristic, as input, to a classifier; and
determining, based on the classifier, whether to partition the frame according to the identified partitioning option.

2. The method of claim 1, wherein the partitioning option comprises a coding tree unit (CTU).

3. The method of claim 2, wherein identifying the partitioning option comprises:
identifying a first candidate coding unit (CU) and a second candidate CU;
determining a first cost associated with the first candidate CU and a second cost associated with the second candidate CU; and
determining that the first cost is lower than the second cost.

4. The method of claim 3, wherein the at least one characteristic comprises at least one characteristic of the first candidate CU.

5. The method of claim 1, wherein identifying at least one characteristic corresponding to the partitioning option comprises determining at least one of the following:
an overlap between the first candidate CU and at least one of a segment, an object, and a group of objects;
a ratio of a coding cost of the first candidate CU to an average coding cost of the video frame;
a neighbor CTU split decision history; and
a level in a CTU quad tree structure corresponding to the first candidate CU.

6. The method of claim 1, wherein providing the at least one characteristic, as input, to the classifier comprises providing a characteristic vector to the classifier, wherein the characteristic vector includes the at least one characteristic.

7. The method of claim 1, wherein the classifier comprises a neural network or a support vector machine.

8. The method of claim 1, further comprising:
receiving a plurality of test videos;
analyzing each of the plurality of test videos to generate training data; and
training the classifier using the generated training data.

9. The method of claim 8, wherein the training data comprises at least one of localized frame information, global frame information, output from object group analysis and output from segmentation.

10. The method of claim 8, wherein the training data comprises a ratio of an average cost for a test frame to a cost of a local CU in the test frame.

11. The method of claim 8, wherein the training data comprises a cost decision history of a local CTU in the test frame.

12. The method of claim 11, wherein the cost decision history of the local CTU comprises a count of a number of times a split CU is used in a corresponding final CTU.

13. The method of claim 8, wherein the training data comprises an early coding unit decision.

14. The method of claim 8, wherein the training data comprises a level in a CTU tree structure corresponding to a CU.

15. The method of claim 1, further comprising:
performing segmentation on the frame to produce segmentation results;
performing object group analysis on the frame to produce object group analysis results; and
determining, based on the classifier, the segmentation results, and the object group analysis results, whether to partition the frame according to the identified partitioning option.

16. One or more computer-readable media having computer-executable instructions embodied thereon for encoding video, the instructions comprising:
a partitioner configured to:
identify a partitioning option comprising a candidate coding unit; and
partition the frame according to the partitioning option;
a classifier configured to facilitate a decision as to whether to partition the frame according to the identified partitioning option, wherein the classifier is configured to receive, as input, at least one characteristic corresponding to the candidate coding unit; and
an encoder configured to encode the partitioned frame.

17. The media of claim 16, wherein the classifier comprises a neural network or a support vector machine.

18. The media of claim 16, the instructions further comprising a segmenter configured to:
segment the video frame into a plurality of segments; and
provide information associated with the plurality of segments, as input, to the classifier.

19. A system for encoding video, the system comprising:
a partitioner configured to:
receive a video frame;
identify a first partitioning option corresponding to the video frame and a second partitioning option corresponding to the video frame;
determine that a cost associated with the first partitioning option is lower than a cost associated with the second partitioning option; and
partition the video frame according to the first partitioning option;
a classifier, stored in a memory, wherein the partitioner is further configured to provide, as input, at least one characteristic of the first partitioning option to the classifier and to use an output from the classifier to facilitate determining that the cost associated with the first partitioning option is lower than the cost associated with the second partitioning option; and
an encoder configured to encode the partitioned video frame.

20. The system of claim 19, wherein the classifier comprises a neural network or a support vector machine.
